(19) United States
(12) Patent Application Publication
(10) Pub. No.: US 2009/0153670 A1
(43) Pub. Date: Jun. 18, 2009

(54) HAND HELD DIGITAL PHOTO TRANSFER DEVICE

(76) Inventor: Rhonda Martz, Woodlands, TX (US)

Correspondence Address: HAYNES AND BOONE, LLP;IP Section, 2323 Victory Avenue, Suite 700, Dallas, TX, 75219, US

(21) Appl. No.: 11/958,985

(22) Filed: Dec. 18, 2007

(51) Int. Cl. H04N 5/225

(52) U.S. Cl. 348/207.1; 348/E05.024

(57) ABSTRACT

A system and method for transferring digital photo files from a plurality of different sources having different connection configurations to one or more sources, which may also have a plurality of different connection configurations. The system may generally include a body, a processor in communication with a system bus, at least one memory source, a plurality of input ports being configured to communicate with a different type of digital photo devices, a plurality of output ports being configured to communicate with a different type of digital photo devices, and an input/output device positioned to receive input from an exterior of the body, the input/output device being in communication with the system bus.

### BACKGROUND OF THE DISCLOSURE

1. Field of the Invention

Embodiments of the invention relate to a device configured transfer digital photographs from multiple digital cameras to another digital media storage device.

2. Description of the Related Art

Recent advances in digital technology have revolutionized several areas of society, including the photography industry. Digital cameras provide an affordable, compact, and very convenient method for taking pictures that has recently taken over the photography industry from traditional camera and film arrangements. Digital cameras do not require film, and the photographs can be affordably printed on widely available color printers, thus eliminating photograph processing and the costs associated with conventional film and processing thereof.

One challenge associated with the development of digital cameras is sharing of photographs. More particularly, the advent of digital cameras has allowed people to share photos much easier than with traditional film based cameras, as the digital files can be downloaded to a computer or to a computer disk and e-mailed to others. However, the process of e-mailing photos to others has shown to be time consuming, and as such, often digital photos do not get shared as a result of the time and effort required to download and e-mail photos to others.

Therefore, there is a need for an efficient apparatus and method for sharing photos from digital cameras.

### SUMMARY OF THE DISCLOSURE

Exemplary embodiments of the invention may provide a system and method for efficiently sharing photos from multiple digital cameras.

Embodiments of the invention may generally provide a system for receiving, storing, compiling, and transmitting a plurality of digital files to a plurality of users. The digital files are received from a plurality of individual users, and the individual users may be using varying digital devices having varying and different types of memory or connections thereto that must be used to download the digital files therefrom. The exemplary system of the invention, therefore, includes a plurality of different input ports or interfaces that are configured to interface with a plurality of different digital devices. The exemplary system includes a memory device configured to store a large quantity of digital files therein. The exemplary system allows a user to select a compilation of the plurality of digital files stored therein, and then the exemplary system is configured to transmit the compilation of digital files to a plurality of users.

Embodiments of the invention may generally provide a method for receiving digital files from a plurality of users, storing the receipt of digital files in a digital memory, compiling a selected list of the digital files, and transmitting the digital files represented in the selected list to a plurality of third parties. The plurality of digital files received in the exemplary system of the invention may be received from a plurality of different digital media devices through a plurality of different digital media interfaces. The received files may be stored in a digital memory, and a user may be provided with an input/output device that allows the user to select a compilation of the digital files stored in the memory, and in the compilation may be sent to a plurality parties as selected by the user.

Embodiments of the invention may further provide system for compiling digital photograph files from a plurality of sources. The system may include a body having a rigid outer shell and a hollow interior configured to house electronic components, the body being sized to be handheld and portable; a processor in communication with a system bus, both of which are positioned in the hollow interior of the body; at least one memory source configured to store digital files, and being in communication with the system bus and positioned in the hollow interior; a plurality of input ports in communication with the system bus, the plurality of input ports being at least partially positioned in the hollow interior, each of the plurality of input ports being configured to communicate with a different type of digital photo devices; and a plurality of output ports in communication with the system bus, the plurality of output ports being at least partially positioned in the hollow interior, each of the plurality of output ports being configured to communicate with a different type of digital photo devices; an input/output device positioned to receive input from an exterior of the body, the input/output device being in communication with the system bus, wherein the processor is configured to receive digital files from a plurality of different sources via the plurality of input ports, store the received digital files, compile a list of user selected digital files for transmission, and transmit the compiled a list of user selected digital files to a plurality of receiving devices.

Embodiments of the invention may further provide a method for compiling digital photographs from a plurality of digital cameras. The method may include receiving at a plurality of input ports each configured to communicate with a different type or configuration of digital camera, a plurality of digital files representative of digital photographs, the plurality of input ports being positioned on a handheld file transfer device; storing the plurality of digital files in a flash memory contained in the handheld file transfer device; receiving an input from a user on a keyboard positioned on the handheld file transfer device, wherein the input represents a user selected compilation of digital files; and transmitting a plurality of digital files representative of the user selected compilation to at least one external device through at least one of a plurality of output ports.

Embodiments of the invention may further provide a system for compiling digital photographs from a plurality of digital cameras. The system may include a receiving means for receiving at a plurality of input ports each configured to communicate with a different type or configuration of digital camera, a plurality of digital files representative of digital photographs, the plurality of input ports being positioned on a handheld file transfer device; a storing means for storing the plurality of digital files in a flash memory contained in the handheld file transfer device; an input receiving means for receiving an input from a user on a keyboard positioned on the handheld file transfer device, wherein the input represents a user selected compilation of digital files; and a transmitting means for transmitting a plurality of digital files representative of the user selected compilation to at least one external device through at least one of a plurality of output ports.

### BRIEF DESCRIPTION OF THE DRAWINGS

FIG. 1 illustrates an exemplary photo transfer system of the invention.

FIG. 2 illustrates an exemplary method for receiving, compiling, and transmitting digital photos to users of multiple digital cameras.

### DETAILED DESCRIPTION

Applicants note that the following description references exemplary embodiments of the invention. The invention, however, is not limited to any specifically described exemplary embodiment; rather, any combination of the following features and elements, whether related to a described embodiment or not, may be used to implement and/or practice the invention. Moreover, in various embodiments, the invention may provide advantages over the prior art; however, although embodiments of the invention may achieve advantages over other possible solutions and the prior art, whether a particular advantage is achieved by a given embodiment is not intended in any way to limit the scope of the invention. Thus, the following aspects, features, embodiments, and advantages are intended to be merely illustrative of the invention and are not considered elements or limitations of the appended claims; except where explicitly recited in a claim. Similarly, references to “the invention” herein should neither be construed as a generalization of any inventive subject matter disclosed herein nor considered an element or limitation of the appended claims; except where explicitly recited in a claim.

Further, at least one embodiment of the invention may be implemented as a program product for use with a computer system or processor. The program product may define functions of the exemplary embodiments (which may include methods) described herein and can be contained on a variety of computer readable media. Illustrative computer readable media include, without limitation, (i) information permanently stored on non-writable storage media (e.g., read-only memory devices within a computer such as CD-ROM disks readable by a CD-ROM drive); (ii) alterable information stored on writable storage media (e.g., computer disks for use with a disk drive or hard-disk drive, writable CD-ROM disks and DVD disks, zip disks, portable memory devices, and any other device configured to store digital data); and (iii) information conveyed across communications media, (e.g., a computer, telephone, wired network, or wireless network). These embodiments may include information shared over the Internet or other computer networks. Such computer readable media, when carrying computer-readable instructions that perform methods of the invention, may represent embodiments of the present invention.

Further still, in general, software routines or modules that implement embodiments of the invention may be part of an operating system or part of a specific application, component, program, module, object, or sequence of instructions, such as an executable script. Such software routines typically include a plurality of instructions capable of being performed using a computer system or other type or processor configured to execute instructions from a computer readable medium. Also, programs typically include or interface with variables, data structures, etc. that reside in a memory or on storage devices as part of their operation. In addition, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways.

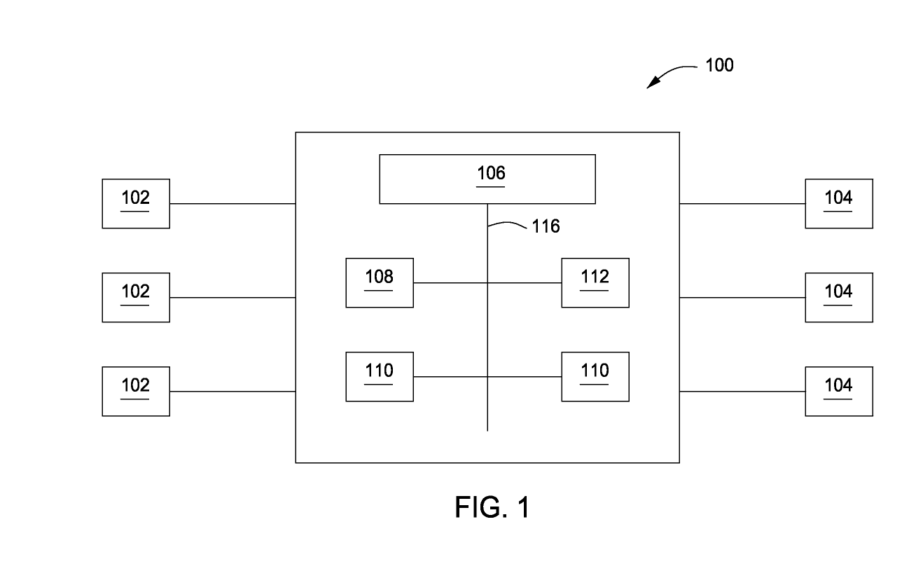

FIG. 1 illustrates an exemplary photo transfer system of the invention. The system 100 may generally include a main body 106, which may of any suitable size or shape. Generally, main body 106 will be sized to be portable, i.e., main body 106 will generally be sized to be handheld. Thus, the main body 106 may be between about 1 inch and about 4 inches wide, between about 1 inch and about 5 inches tall, and less than about 2 inches thick. The main body may generally include a protective outer casing configured to safely contain electronic components therein. The main body 106 may include a plurality of input interfaces or ports 102, generally between about 2 and about 6 input interfaces 102 may be used for a single system 100, however, the invention is not limited to any particular number of input interfaces 102. The input interfaces 102 may be wired connection sites, receptacles configured to receive or otherwise engage a memory device for communication therewith, or any other mechanical means or device that provides for communication with a digital storage device. The input interfaces 102 may generally be positioned on the main body 106 and are configured to connect to external devices. Thus, the input interfaces 102 may comprise a connector or receptacle configured to connect to or otherwise communicate with a device containing digital media their own.

The main body 106 may also include a plurality of output interfaces or ports 104. Generally between about 2 and about 6 output interfaces 104 may be used for a single system 100, however, the invention is not limited to any particular number of output interfaces 104. The output interfaces 104 may be wired connection sites, receptacles configured to receive or otherwise engage a memory device for communication therewith, or any other mechanical means or device that provides for communication with a digital storage device.

The main body 106 may also include an I/O device 106, which may be any one component of or a combination of a keyboard, screen, mouse, stylus and stylus pad, roller or slide buttons, and display LEDs or other visual indicators. The I/O device 106 may generally be positioned on an exterior surface of the main body 106, in similar fashion to conventional PDA devices. As such, the I/O device 106 may generally include a keyboard or user data entry and a corresponding display screen for displaying the status of the system 100 during operation.

The I/O device 106 may generally be in communication with a data bus 116, wherein the data bus 116 is in communication with each component of system 100. the data bus 116, which is generally known in the computing art, may be configured to communicate digital information between the various components of system 100, as further described herein. The data bus 116 may be in communication with each of the input interfaces 102 and the output interfaces 104, thus providing a communication path between the input and output of system 100, however, it is to be understood that several electronic components configured to receive process and output digital data may be positioned between the input port 102 and the output port 104.

A processor 108 is also in communication with the data bus 116. The processor 108 may be any type of micro processor configured to execute instructions contained in a computer program, memory element, or other digital storage medium. the processor 116 may also be any type of programmable logic device, computer chip, or other electronic device configured to process digital data based upon a predetermined set of instructions, i.e., a computer program. The data bus 116 may also be in communication with at least one data storage element 110, which may be any type of digital storage medium. Examples of digital storage media include various types of computer memory, including hard disk drives, RAM, ROM, flash memory, memory sticks, SD memory, and any other type of memory generally found in the computer, telecommunications, photography, or digital data processing industries.

Data bus 116 may also be in communication with an output module 112. the output module 112 may generally be configured to transmit information received therein to at least one of the output ports 104 or another output device. For example, output ports 104 may be traditional wire-type output ports configured to mechanically connect to various memory devices. However, additional non-wired input and output ports are contemplated within the scope of the invention. For example, output port 114 may be an RF transmission port or an IR transmission port configured to transmit data from system 100 to a remotely positioned device via radio frequency or infrared communications. The input ports 102 may similarly be either wired or non-wired type connections. Therefore, the output module 112 is generally configured to receive data from the other internal processing elements of system 100, and then transmit they received data to other external devices or components via the output ports 104.

The input ports 102 and output ports 104 are generally configured to provide a plurality of different configurations for a communicating with various types of digital storage devices. For example, the inventor contemplates that input ports 102 and output ports 104 may be configured to communicate with any number of digital storage devices, such as PC cards, compact flash memory, smart media, memory sticks, multimedia cards, secure digital cards, SD memory cards, flash memory, micro cards, and any other type of digital storage media typically used in the photography or music storage industries. The output ports 102 and 104 may be configured to receive directly therein various types of memory cards via receptacles that are sized and positioned to receive specific types of memory cards therein. Additionally, input and output ports 102 and 104 may also include various types of wired connectors configured to communicate with various types of digital storage media contained in other devices, such as digital cameras and digital music players. The wired connections, e.g., the input and output ports 102, 104, may generally be configured to connect with external devices via a wired connection specifically designed to plug into the external device while also plugging into the port 102, 104. Thus, since system 100 includes a plurality of different input ports 102 and a plurality of different output ports 104, system 100 is configured to receive digital files from various types of digital sources, and to communicate files stored there into various types of digital devices.

The configuration of system 100 provides a device that is capable of receiving digital files or photos from multiple digital cameras, each of which may have a different type of connector, storing the received digital files therein, and then transmitting a selected compilation of the received digital files to a digital device in communication with one of the output ports 104. Therefore, in the situation where there are a plurality of digital cameras, each of which may be owned by a different user, system 100 may be used to download or receive the digital photos contained on each of the plurality of digital cameras through one or more of input ports 102. The process of downloading the digital photos or other types of digital media may be conducted simultaneously through each of system 100s input ports 102.

The compilation of photos received may be stored in system 100 (in memory 110, for example), and then the compilation of photographs (or a subset thereof) may be transmitted, individually or in bulk, to a selected group, which may include each owner of the plurality of digital cameras contributing photos to system 100. Therefore, system 100 provides an efficient system and method for users of digital cameras (or digital music devices) to share digital files with each other in a real time or on-site manner.

The conventional method for sharing photos or other digital files in this situation would generally include each user of the plurality of digital cameras returning to a computer (which often times is remotely positioned), downloading the photos, and then e-mailing the photos to each of the other camera owners. Thus, the portable system 100 of the present invention allows for an easy, efficient, and on-site method for sharing photos, that does not require each user to remember to download and send the photographs to each of the other users, which although it sounds easy, generally presents challenges to users of digital cameras.

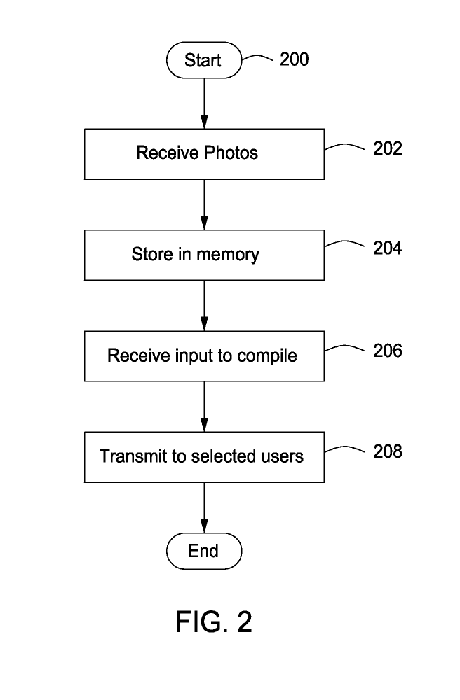

FIG. 2 illustrates an exemplary method for receiving, compiling, and transmitting digital photos to users of multiple digital cameras. The exemplary method begins at step 200, and continues to step 202, where files representing the digital photos are received by the exemplary system 100 of the invention. The files, which are generally digital files, may include one or a plurality of digital photos of therein. Additionally, the files may be received from one or a plurality of sources, i.e. a plurality of different digital cameras, each of which may connect to various input ports 102 of system 100. The digital files communicated to system 100 may be communicated thereto simultaneously from a plurality of devices, or each individual device may you be individually connected to system 100 at different times.

The digital files that are communicated to system 100 via the input ports 102 are generally stored in memory 110 within system 100, as illustrated at step 204. The memory 110 may be configured to store hundreds or even thousands of digital files. For example, memory 110 may contain at least 10 GB of memory storage space, and in several embodiments may contain hundreds of gigabytes of data storage space. The digital files may be stored in memory 110 in an organized or indexed manner, so that individual files or photos from memory 110 may be selected by a user for transmission out of system 100. The organizational or indexing scheme used to store the digital files may include an identifier representing the origin of the file. For example, each digital file may be appended with an identifier that indicates which user or camera of the digital file came from. The appended identifier, which may generally comprise a small number of digital bits or bytes added to the original digital file, may be saved in memory 110 as a single file, or alternatively, system 100 may maintain an association file containing the appended identifiers and their relationship to a specific file in memory 110.

Once a user has received the desired digital files in system 100, the user may then select one or a plurality of the digital files for stored within memory 110 for transmission to a third-party device or devices. For example, the user may he download or receive over 100 photographs from a plurality of different digital cameras, and then select a smaller set, i.e., about 25, of the photographs for transmission to each of the digital camera owners that contributed to the original 100 photographs. The process of selecting the photographs to be transmitted to third-party users is illustrated at step 206 in FIG. 2. Once the photographs or digital files have been selected and compiled for transmission, system 100 may begin the process of transmitting the compilation of files or photos to individual users, as represented at step 208. However, the process of compiling the digital files for transmission may include appending the aforementioned identifier to each digital file to be transmitted. The identifier, as described above, may be used to identify the source location of the digital file to subsequent users or viewers of the file, i.e., the identifier may indicate who took the digital photo to those who subsequently view the photo.

In an alternative embodiment of the invention, system 100 may append the identifier to the associated digital file in a manner that is viewable by subsequent users when viewing the actual file. For example, the identifier may be overlaid onto the digital file when viewed. Thus, a person viewing a digital file received from system 100 may view the file with an identifier overlaid on the file, wherein the identifier indicates who originally took the photograph. The identifier may be positioned discreetly in a corner of the photograph so as not to distract from the content of the photograph.

In another embodiment of the invention, the overlay identifier may comprise a copyright notice. In this embodiment, system 100 may be used to generate an overlay identifier for digital file, and the overlay identifier may be merged into or permanently associated with the digital file. The permanent association of the identifier, which may generally be the copyright notice, may be used to prevent subsequent users of the digital file or photograph from removing the copyright notice.

The process of transmitting the selected compilation of digital photos or files to individual users may include connecting individual user devices to system 104, and transmitting the compilation of photographs to the individual user's device via one of output ports 104. Thus, in an embodiment where system 100 includes multiple output ports, then multiple different users may receive the selected compilation of digital photos or files from system 100 at the same time, as each user may connect to an individual output 104 of system 100 simultaneously. Once the compilation of photos or digital files have been transmitted to the individual users, the method ends at step 210.

In another exemplary embodiment of the invention, the process of transmitting the compilation of digital photos or files to contributing users may include using a wireless transmission method. For example, system 100 may be configured to include a cellular or satellite communications system that may be used to transmit electronic mail messages. In this configuration, photos from a plurality of digital cameras may be downloaded to system 100, and then the user of system 100 may inter e-mail addresses for each of the contributing parties. System 100 may then send an e-mail message to each of the contributing parties containing the compilation of photographs received in system 100. Thus, after each camera owner downloads their photographs to system 100, the user may send a compilation of photos to each user quickly and efficiently. Embodiments of the invention are not intended, however, to be limited to cellular, infrared, or radio frequency type communications systems. Rather, the inventors contemplate that any type of communications system capable of sending e-mail type messages may be used without departing from the scope of the present invention.

In another exemplary embodiment of the invention, system 100 may be incorporated into an existing electronic device. For example, system 100 may be incorporated into an existing personal computer, where in the personal computer is configured with a plurality of input or output interfaces. For example, a serial or USB port of a computer may be configured with a pigtail type connector that is designed to communicate with a plurality of digital media devices. In this configuration, the digital media devices may be connected to the pigtail device, digital files may be downloaded there from and stored on the personal computer, had been transmitted via electronic mail message to a plurality of users. Similarly, system 100 may be incorporated into other electronic devices, such as cell phones, PDA devices, digital music devices, and any other type of digital media device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A system for compiling digital photograph files from a plurality of sources, comprising:
a body having a rigid outer shell and a hollow interior configured to house electronic components, the body being sized to be handheld and portable;
a processor in communication with a system bus, both of which are positioned in the hollow interior of the body;
at least one memory source configured to store digital files, and being in communication with the system bus and positioned in the hollow interior;
a plurality of input ports in communication with the system bus, the plurality of input ports being at least partially positioned in the hollow interior, each of the plurality of input ports being configured to communicate with a different type of digital photo devices;
a plurality of output ports in communication with the system bus, the plurality of output ports being at least partially positioned in the hollow interior, each of the plurality of output ports being configured to communicate with a different type of digital photo devices; and
an input/output device positioned to receive input from an exterior of the body, the input/output device being in communication with the system bus,
wherein the processor is configured to receive digital files from a plurality of different sources via the plurality of input ports, store the received digital files, compile a list of user selected digital files for transmission, and transmit the compiled a list of user selected digital files to a plurality of receiving devices.

2. The system of claim 1, the at least one memory source comprises flash memory.

3. The system of claim 2, wherein the flash memory has a capacity of at least 10 gigabytes.

4. The system of claim 1, wherein the plurality of input ports are configured to received both wired and wireless communications.

5. The system of claim 1, wherein the plurality of output ports are configured to transmit both wired and wireless communications.

6. The system of claim 5, wherein the wired and wireless communications comprise electronic mail messages containing digital files representing the compiled list.

7. The system of claim 1, wherein the input/output device comprises a keyboard configured to receive user input and a display screen configured to display outputs from the system to the user.

8. A method for compiling digital photographs from a plurality of digital cameras, comprising:
receiving at a plurality of input ports each configured to communicate with a different type or configuration of digital camera, a plurality of digital files representative of digital photographs, the plurality of input ports being positioned on a handheld file transfer device;
storing the plurality of digital files in a flash memory contained in the handheld file transfer device;
receiving an input from a user on a keyboard positioned on the handheld file transfer device, wherein the input represents a user selected compilation of digital files; and
transmitting a plurality of digital files representative of the user selected compilation to at least one external device through at least one of a plurality of output ports.

9. The method of claim 8, further comprising adding an overlay to each of the plurality of digital files transmitted.

10. The method of claim 9, wherein the overlay comprises a copyright notice.

11. The method of claim 8, wherein each of the plurality of input ports is configured to communicate with a different type of digital media source.

12. The method of claim 8, wherein transmitting the plurality of digital files comprises transmitting the files in an electronic mail message.

13. The method of claim 9, wherein the electronic mail message is sent from the handheld file transfer device via a wireless communications system.

14. The method of claim 8, wherein transmitting the plurality of digital files comprises transmitting to a plurality of different external devices via the plurality of output ports, wherein the plurality of output ports are each configured to communicate with a different type of external device.

15. The method of claim 8, wherein the receiving step is conducted simultaneously for the plurality of digital sources through each of the plurality of input ports.

16. A system for compiling digital photographs from a plurality of digital cameras, comprising:
receiving means for receiving at a plurality of input ports each configured to communicate with a different type or configuration of digital camera, a plurality of digital files representative of digital photographs, the plurality of input ports being positioned on a handheld file transfer device;
storing means for storing the plurality of digital files in a flash memory contained in the handheld file transfer device;
input receiving means for receiving an input from a user on a keyboard positioned on the handheld file transfer device, wherein the input represents a user selected compilation of digital files; and
transmitting means for transmitting a plurality of digital files representative of the user selected compilation to at least one external device through at least one of a plurality of output ports.
